(19) United States
(12) Patent Application Publication
(10) Pub. No.: US 2013/0220946 A1
(43) Pub. Date: Aug. 29, 2013

(54) FOAM DRIVE SYSTEM AND METHOD FOR DEWATERING FILTER CAKE

(71) Applicant: Edgar B. Klunder, Bethel Park, PA (US)

(72) Inventor: Edgar B. Klunder, Bethel Park, PA (US)

(21) Appl. No.: 13/407,566

(22) Filed: Feb. 28, 2012

(51) Int. Cl. B01D 29/00

(52) U.S. Cl. 210/808; 210/416.1

(57) ABSTRACT

A system and method for extracting liquid and/or solids from interstices of a porous matrix is disclosed. The porous matrix has two exposed ends, one of which is exposed to a first pressure and at an upstream end and another one of which is exposed to a second pressure and at a downstream end. The method includes first providing a pressure differential between the first pressure and the second pressure, wherein the first pressure is higher than the second pressure. This is then followed by providing foam on the upstream end, where the pressure differential is configured to cause foam movement through the interstices of the porous matrix to extract the liquid and/or solids through the downstream end.

### BACKGROUND OF THE INVENTION

1. The Field of the Invention

The present invention is directed generally to a system and method for extracting solids and/or liquids from a material matrix. More specifically, the present invention is directed to a dewatering system and method as applied to porous matrix such as filter cake.

2. Background Art

Minerals, including coal, typically undergo wet beneficiation that can lead to expensive subsequent dewatering operations, especially for the portion of the product stream containing fines. Competing options are thermal drying (natural gas) and pressure filtration. Vacuum filtration and centrifugation result in an even wetter cake of product. Most coals are cleaned at relatively coarse sizes typically in the range of two inches and 48 mesh. Finer coals are often discarded because of the high costs of processing. Although the amount of the fines discarded is relatively small as compared to the coarse particles that are cleaned, it represents a significant loss of valuable resources and creates environmental problems. Despite the technological advancement made in recent years, the U.S. coal industry is still discarding about 30 to about 50 million tons of the fine coal to impoundments annually in the U.S. More than 2 billion tons are already found in such impoundments, primarily attributable to the high cost of dewatering.

All together, about 10 billion tons of rock are processed by wet flotation technology to obtain minerals worldwide each year. The dewatering cost for the mineral concentrate streams is passed on to the consumer. The reject rock, or refuse slurry, is typically sent to settling/tailings ponds, with the intent of recycling at least a portion of the process water. A low-cost dewatering step for the refuse slurry in addition to dewatering of the product stream may facilitate recovery and conservation of scarce water resources.

Solid-liquid separation is a major unit operation that is practiced in the chemical process industries, ore beneficiation, pharmaceutics, food or water and waste treatment. The separation techniques are very diverse depending on the goals of the overall process, but they generally involve the passage of most of the fluid through a porous barrier which retains the solid particles contained in the feed mixture. Such filtration can be classified by the driving force used to induce the flow through the filter medium and by the mechanism of solids accumulation. Pressure can be applied upstream of the filter medium, vacuum or reduced pressure applied downstream of the filter medium, or centrifugal force applied across the medium. In cake filtration, the dominant solids accumulation mode, the solids are stopped at the surface of a filter medium and pile upon one another to form a cake of increasing thickness. In a less common mode of depth filtration, the solids are trapped within the pores or body of the medium.

The process objective of filtration may be the drying of the cake when the cake is the desired product with high value, the clarified liquid or filtrate, or both.

The economic requirement for drier cakes is being driven by higher energy prices. Thermal secondary driers with expensive fuel needs are frequently employed to meet targets, especially in the minerals and metallurgical industries. Mineral concentrates often need to be shipped over long distances, made more expensive by wetter cakes, and subsequent smelting of such cakes increases energy consumption further. Furthermore, our limited ore resources have been declining in quality over the years, thus pushing mineral processing and ore beneficiation industries to finer ore crushing and grinding requirements for more complex and lower grade ores. The resultant finer flotation concentrates offer more cake resistance and greater challenges during dewatering for meeting cake moisture goals. Anode slimes present in electro-refining circuits are collected and filtered for recovery of precious metals. Precipitated metal hydroxides may also be dewatered for disposal or recycle. Such products are generally even more difficult to dewater than flotation concentrates, in part because of their smaller particle sizes.

Efficient dewatering is a currently elusive goal of the renewable fuels industry that is working on the thermal/catalytic conversion of wet biomass feed stocks such as algal slurries, lignin slurries, and sewage sludge into refined liquid fuels. Conventional dewatering techniques rarely achieve sufficient dryness for direct feeding to gasifiers without huge thermal penalties.

The recovery of increasing amounts of filtrate from a filter cake is also becoming a critical goal for industry. More filtrate can become available for recycle as process water and thus result in a decrease in net water consumption. An even more economically important goal in hydrometallurgical processes is the maximum recovery of more valuable leach solutions for recycle when solids that have been subjected to such extraction need to be separated from the leach solutions.

Waste tailings disposal is receiving increased scrutiny, and a shift toward paste and dry disposal after dewatering is likely in order to meet environmental regulations. Such interest in enhanced water recovery is especially noteworthy in arid regions and for areas of seismic activity where there is a concern with conventional impoundment dams.

Conventional filtration, whether via pressure, vacuum, or enhanced gravity (centrifugation) suffers from several drawbacks that impede the removal of liquids from the interstitial void spaces and pores in the filter cake. Such filtration depends on single phase gas and liquid drives that are inefficient. Single phases tend to find the path of least resistance, thereby exhibiting ‘fingering’ effects and premature breakthrough, especially in heterogeneous matrices. Even carefully prepared filter cakes contain variations in the size of local voids and some stratification of particles. These inhomogeneities permit preferential flow of gas through such available larger channels, and the gas thus has no opportunity to displace liquids from the smaller channels and pores. Furthermore, as liquid is being pushed out conventionally, the dryer portions of the filter cake are likely to crack, thus forming additional detrimental avenues for gas bypass.

A refinement of conventional filtration for dewatering purposes is the use of chemical additives as dewatering aids. Lower filter cake moisture can be obtained by the addition of the appropriate surfactant during the filtration dewatering of fine clean coal. Reference is made to B. P. Singh, Fuel 78501-506 (1999), U.S. Pat. No. 5,670,056 to Yoon et al., U.S. Pat. No. 6,526,675 to Yoon and U.S. Pat. No. 5,089,142 to Turunc. The mechanism by which a surfactant brings about the improved dewatering is complex, but it appears to involve the reduction of the surface tension of the filtrate and an increase in the hydrophobicity of the particle surfaces as reflected in an increase in the solid to liquid contact angle. The water molecules adhering to the surfaces are destabilized and thus more readily removed during the process of mechanical dewatering.

Foam flow studies have been carried out for potential application of foam to enhance oil recovery from petroleum reservoirs. Foams can reduce gas mobility within porous media and thus improve sweep efficiency. U.S. Pat. No. 5,060,727 to Schramm et al. discloses a method of improving enhanced oil recovery using foams. Reference is also made to Kam, S. I., and Rossen, W. R., “A Model for Foam Generation in Homogeneous Media,” SPE 77698 presented at the 2002 SPE Annual Technical Conference, San Antonio, Tex., Sep. 29-Oct. 2, 2002. Reference is further made to Xu, Q, and Rossen, W. R., “Experimental Study of Gas Injection in Surfactant-Alternating-Gas Foam Process,” paper SPE 84183 presented at the 2003 SPE Annual Technical Conference, Denver, Colo., Oct. 5-8, 2003.

Foam is used as well in matrix acid well stimulation. Reference is made to Xu, Q., and Rossen, W. R., “Laboratory Study of Gas Trapping in Foam-Acid Diversion,” paper SPE 84133 presented at the 2003 SPE Annual Technical Conference, Denver, Colo., Oct. 5-8, 2003. Application of foam is being extended to environmental remediation as disclosed in Mamun, C. K., Rong, J. G., Kam, S. I., Liljestrand, N. M., and Rossen, W. R., “Extending Foam Technology from Improved Oil Recovery to Environmental Remediation,” SPE 77557 presented at the 2002 SPE Annual Technical Conference, San Antonio, Tex., Sep. 29-Oct. 2, 2002. Reference is further made to Rothmel, R. K., Peters, R. W., St. Martin, E., and DeFlaun, M. F., “Surfactant Foam/Bioaugmentation Technology for In Situ Treatment of TCE-DNAPLs,” Environ. Sci. Technol. 1998, 32, 1667-1675 (hereinafter Rothmel).

In the case of DNAPL recovery tests of Rothmel, surfactant foams were found to be 10 times more efficient than surfactant solutions in removing hydrophobic NAPL-like contaminants from porous media.

Minerals such as coal, clays, phosphates, sulfides, and the like, including mineral sources of metals such as copper, tungsten, silver, and gold, are often mixed with water to form an aqueous slurry for various processing operations. For example, U.S. Pat. Nos. 4,981,582, 5,167,798, and 5,397,001, all to Yoon et al., describe microbubble flotation technology used to separate fine particles of minerals or coal from non-valuable materials. Also, waste materials are often disposed of with water in various sewage handling operations.

While water provides a convenient medium for performing a wide variety of operations, such as cleaning, material transport, reaction chemistry, etc., problems arise when the ultimate product desired is dried particulate material. When water clings to the surfaces of valuable materials such as coal, clays, minerals, metals, etc., it adds non-useful weight to the material. This weight increases the cost of transporting the material by truck or train. In addition, the water may affect the performance of the material. For example, coal burns less efficiently. The problem of surface water clinging to particulates is most severe in smaller particles, such as particles of less than 0.5 mm in diameter. This is due to the smaller particles having much higher surface-to-volume ratios.

A wide variety of technologies have been developed to dry particulate matter. One method simply involves removing water by heating the material. Thermal heating requires a significant amount of energy input. The energy must be sufficient to overcome the attraction between the water molecules with each other and the particulate material, thereby vaporizing the water and leaving a dry material. As a practical matter, the cost of the energy required to thermally dry the particulate material may be more expensive than the value of the particulate material to be salvaged. In addition, the thermal drying technique would be ineffective for particulate materials which liquify or undergo a phase change below the temperature required for water removal, and the thermal drying technique poses environmental problems due to the requirement of large amounts of air input and steam effluent.

Another method involves mechanically removing water by vacuum filtration, pressure or hyperbaric filtration, centrifugation, etc. While these techniques do not expose the particulate matter to heat, they still require a large amount of energy input. Under these methods, energy is required to overcome the force of attraction of the water molecule to the particulate matter. Current mechanical dewatering techniques have not proven satisfactory in achieving a suitable dryness in coal and minerals processing operations. In addition, these techniques are time consuming, and often involve tedious steps such as the separation of caked particulates. Currently, small particles of phosphates, coal, and other minerals, are often discarded due to difficulties in cleaning and drying the particles. This practice is tremendously wasteful and has an adverse impact on the environment.

There are two reasons for the high costs of processing fine coals. One is the low efficiency of cleaning and the other is associated with the high cost of dewatering. The first problem has been resolved to a large extent by the advent of advanced coal cleaning technologies such as microbubble column flotation and selective agglomeration. These water-based processes are capable of recovering the fine coal from finely dispersed ash and SO₂ forming minerals; however, it is difficult to remove the free water adhering to the surfaces of the fine coal particles. The finer the particle, the larger the surface area and, hence, the more difficult it becomes to dewater the clean coal product. Typically, 100 mesh flotation products contain about 30% to about 40% moisture after a mechanical dewatering process such as vacuum filtration, causing not only a loss of heating values, but also problems with handling and transportation. Some consider that cleaning fine coal replaces one type of inert substance (i.e., ash-forming minerals) by another (i.e., water), offering no financial incentives for coal companies to clean fine coals. Thermal drying can remove the moisture, but it is costly and usually requires cumbersome permitting processes. The cost of thermal drying is estimated in the range of $2-25 per ton of coal, which are substantially higher than those for mechanical dewatering processes.

Many investigators suggested methods of improving the efficiency of mechanically removing water from bituminous coal fines. These include polymer addition, surfactant addition and use of electrical or acoustic energy to aid in the dewatering process. Some of these methods showed improvements in dewatering rate, but not necessarily in reducing the final moisture content. The use of high pressure filters vastly improved the kinetics and reduced the final moisture contents beyond what can be achieved with conventional vacuum filters; however, the final moisture contents are still far above the levels that can be achieved by thermal drying. Furthermore, the high-pressure filters suffer from high capital and maintenance costs.

The most commonly used mechanical dewatering devices are vacuum filters. With this technique, the finer particles fill the voids between coarser particles in the filter cake, significantly increasing the pressure drop. Various flocculating agents, such as organopolysiloxanes as disclosed in U.S. Pat. Nos. 4,290,896 to Gordon et al. and 4,290,897, to Swihart are designed to minimize the blockage by flocculating the particles and thereby increase the filtration rate. Various surfactants have also been used as dewatering aids, the role of which is to increase the filtration rate rather than reduce the final moisture content.

There is an entirely different kind of dewatering problem than discussed above facing the coal industry. The low-rank coals mined in the western U.S. contain about 30% to about 35% moisture as they are formed underground. The water in these coals are referred to as inherent moisture as it constitutes an integral part of the coal structure, and is distinguished from the free moisture adhering to the surface of higher-rank coals. The only way to remove the inherent moisture is to subject the coal to high pressure and/or temperature, which is substantially more costly than removing the free moisture from the higher-rank coals such as bituminous coals. There are many different methods of upgrading low-rank coals by removing the inherent moisture.

Some of the low-rank coal beneficiation techniques describe methods of removing water after removing the inherent moisture. For example, U.S. Pat. No. 4,185,395 to Nakako et al. discloses a method in which brown coal mixed with hydrocarbon oil is heated to 100° C. to 130° C. and then passed through a gas-liquid separation process to separate the slurry into a stream containing the hydrocarbon vapor and a dehydrated slurry. The hydrocarbon oil is recycled in the process. The Nakako et al. process suffers from the drawback that it is a thermal drying process which is energy intensive.

U.S. Pat. No. 3,992,784 to Verschuur et al. also discloses a method of heating an aqueous slurry of brown coal to 150° C. in the presence of hydrocarbon oils. In the example experiments n-C12 hydrocarbon oils have been used to obtain products containing moisture in the range of 31% to 54%.

The need for dewatering is not limited to the mineral processing industry. The article “Turning a Profit from Bark and Sludge,” October 2002 of Fiber & Pulp Industry publication disclosed the consequences of using wet biomass:
“In boilers, the presence of a large agglomeration of wet biomass causes the fire to become uneven. The combustion is poor and a significant quantity of unburned material needs to be transported to the landfill. The reduced boiler efficiency, the cost of fuel, the trucking and unburned material and, often, excess sludge all add up to millions of dollars in avoidable costs.”
“A boiler that has reached its maximum capacity can be made to produce a lot more power and steam production can be increased considerably by removing 50% to 75% of the water contained in the wet biomass before it reaches the boiler.”
“With drier hog fuel, the flame is hotter, much less heat goes up the stack and the combustion process becomes much more efficient. Opinions vary on the increased boiler efficiency, but there is at least a ½% and up to a 1% efficiency gain for every 1% of reduction in fuel moisture. When electricity is generated from steam, an increase in boiler efficiency may make it possible to reduce the purchase of expensive electricity from outside vendors.”
“Incinerating dry sludge can now be done efficiently in a regular grate boiler avoiding the large investment (and operating cost) associated with a fluidized bed boiler. The efficiency of any boiler will increase considerably when wet bark and sludge are dried to 60% or 80% solids before incineration.”

Given the foregoing, what is needed is a system and method that is environmentally safe, effective, and inexpensive method for dewatering particles, especially those of valuable mineral fines, that will allow the recovery and use of material which would otherwise be discarded. In light of existing dewatering systems, there also exists a need for a system and method which is capable of resulting in lower amounts of moisture content in filter cakes than using alternative solutions or alternative solutions alone.

### SUMMARY OF THE INVENTION

The present invention meets the above-identified needs by providing systems and methods for extracting liquid and/or solids from interstices of a porous matrix.

In one aspect, the present invention provides a method for extracting liquid and/or solids from interstices of a porous matrix having two exposed ends, one of which is exposed to a first pressure and at an upstream end and another one of which is exposed to a second pressure and at a downstream end.

The method relates to the separation of liquids from solids by the application of strong foams during the separation process. Strong foam is forced through a porous matrix such as a wet filter cake to remove residual moisture retained within the interstices. The physics of foam structure creates an effective sweep of such matrices with much less channeling than occurs in conventional filtration. Foam can be applied from an external source, as a portion of the feed slurry, or generated in situ. The driving force can be mechanical, gravitational, or various pressurized gases such as air, N₂, CO₂, etc. The method includes the steps of:

(a) providing a pressure differential between the first pressure and the second pressure, wherein the first pressure is higher than the second pressure;
(b) providing foam on the upstream end,
wherein the pressure differential between the first pressure and the second pressure is configured to cause foam movement through the interstices of the porous matrix to extract the liquid and/or solids through the downstream end.

Accordingly, it is a primary object of the present invention to provide a system and method that achieves the levels of drying of a porous matrix not possible using conventional dewatering methods and systems.

It is another object of the present invention to provide a system and method capable of dewatering a porous matrix without leaving behind undesirable or toxic compounds requiring further and often costly processing steps.

It is another object of the present invention to provide a system and method capable of replacing other more costly, wasteful and less environmentally friendly modes of drying such as thermal, chemical and mechanical.

It is yet a further object of the present invention to provide a system and method for dewatering porous matrix which does not require complex setup, high initial investment or operating costs.

The present invention applies to dewatering of coal fines in coal preparation plants, coal fines reclaimed from tailings ponds, reclaimed products from fly ash ponds, mineral concentrate, tailings where water resources are scarce and water recovery for recycling is crucial.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a prior art means for dewatering a porous matrix using a compressing plate or flexible diaphragm.

FIG. 2 depicts another prior art means for dewatering a porous matrix using compressed gas.

FIG. 3 depicts one embodiment of the present invention for dewatering a porous matrix using foam drive.

FIG. 3A depicts another embodiment of the present invention for dewatering a porous matrix using combined foam drive, compressed gas and compressing plate.

FIG. 4 depicts the results of Georgia clay dewatering tests employing Tergitol™ NP-7 surfactant as foam drive.

FIG. 5 depicts a comparison of Tergitol™ NP-7 and NP-9 as foaming agent for Georgia clay dewatering.

FIG. 6 depicts the effect of a thicker cake on Georgia clay dewatering using Tergitol™ surfactant.

FIG. 7 depicts the effect of pH on Georgia clay dewatering when Tergitol™ was used as foaming agent.

FIG. 8 depicts a comparison of generating foam in the slurry and adding already-existent foam on the top of filter cake: 1 represents baseline (pH adjusted to 3, and then Na₂S₂O₄ was added); 2 represents 3 lbs/ton Tergitol™ addition (mixed with aeration to produce foam inside); 3 represents Tergitol™ foam disposed on the top of filter cake.

FIG. 9 depicts the effect of Alum addition on Georgia clay dewatering when Tergitol™ was used as foaming agent.

FIG. 10 depicts the effect of dry cycle time on Georgia clay dewatering when Tergitol™ was used as foaming agent. 1 represents dewatering without Alum; 2 represents dewatering with Alum.

### PARTS LIST

2—chamber
4—upstream end
6—downstream end
8—foam
10—larger interstices
12—smaller interstices
14—liquid trapped in interstices
16—solids trapped in interstices
18—sieve
20—sieve apertures
22—porous matrix
24—compressing plate or flexible diaphragm
26—direction in which compressing plate travels in compressing porous matrix
28—compressed gas on upstream end
30—compressing plate apertures
32—entry point of gas
34—exit point of gas
36—extracted liquid
38—solids collector
40—thickness of porous matrix

### PARTICULAR ADVANTAGES OF THE INVENTION

Foam flow through porous media, such as filter cakes, provides a more effective sweep and penetration of the porous media than simple fluids such as air or water can provide. Fingering of a conventional drive gas and preferential breakthrough of the filter cake characterize conventional filtration and centrifugation causing less efficient removal of moisture. In contrast, foam flow penetrates even the smaller pores to push out entrained liquid from these more difficult portions of the matrix. Any residual foam remaining behind contributes very little moisture. In situ foam formation, especially with CO₂ foam, simplifies foam drive application in that external foam generating methods or equipment are not needed.

A foam-drive test of dewatering a fine clay slurry yielded 25% moisture, a substantial improvement over the typical 35%-45% for pressure filtration (30% is the industry goal). Qualitative tests with fine coal slurries also indicated noticeable moisture lowering over conventional filtration. The invention provides a method for reducing the amount of liquid retained in a porous matrix or filter cake obtained during a solid-liquid separation by the application of foam drive principles. The lowered content of liquid in the solids cake increases the value of the cake for subsequent processing, as well as improves the recovery of liquid for recycle or further use. During foam drive operation, strong foam displaces significantly more residual liquid from the porous filter medium than occurs during conventional filtration. Its performance is based upon the unique structure of strong foam such that foam provides a much more effective sweep of porous media than pure fluids such as gas or water.

Another preliminary foam-drive test on fly-ash pond concentrate obtained by froth flotation yielded about 20% moisture, when conventional vacuum filtration yielded about 39%. Further, the choice of surfactant for foam generation can be tailored to requirements of feed stock/product. The option is available to simplify process/flow sheet for a minerals concentration and recovery plant by filtering flotation froth directly, since flotation froth already contains surfactants that generate foam.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

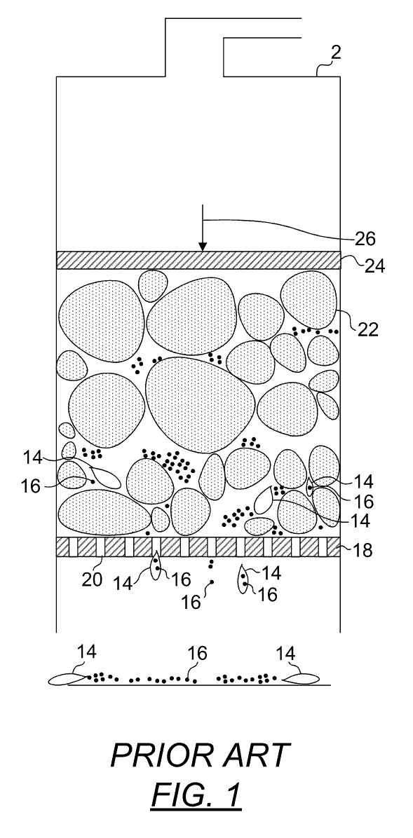

FIG. 1 depicts a prior art means for dewatering a porous matrix 22 using a compressing plate or flexible diaphragm 24. This method is commonly known as pressure filtration and used for separating solids from liquids. Although pressure filtration can take many forms, their common feature lies in the availability and application of high pressure in “squeezing” liquids from solids. The porous matrix 22 can be coal fines, mineral concentrates, Georgia Kaolin Clay (or hereinafter Georgia clay) and the like. In this example, the porous matrix 22 is disposed between a fixedly disposed sieve 18 and a compressing plate 24 in a chamber 2. The compressing plate 24 is then either fluidly or mechanically driven in direction 26, i.e., towards the sieve 18 to “squeeze” the liquid 14 or even small solids 16 trapped in interstices of the porous matrix 22 out through the sieve apertures 20. The effectiveness of this dewatering method depends on the pressure applied by the compressing plate 24 on the porous matrix 22. Typically, such process is capable of drying to 35-45% moisture. Pressure as high as 60 psi is typically required to be exerted to the porous matrix 22 to achieve such a result when Georgia clay slurry is the feed stock. As used herein, compressing plate 24 may also represent any flexible and/or inflatable bag or diaphragm configured for preforming filter cakes and for expressing some of their interstitial liquid and solids.

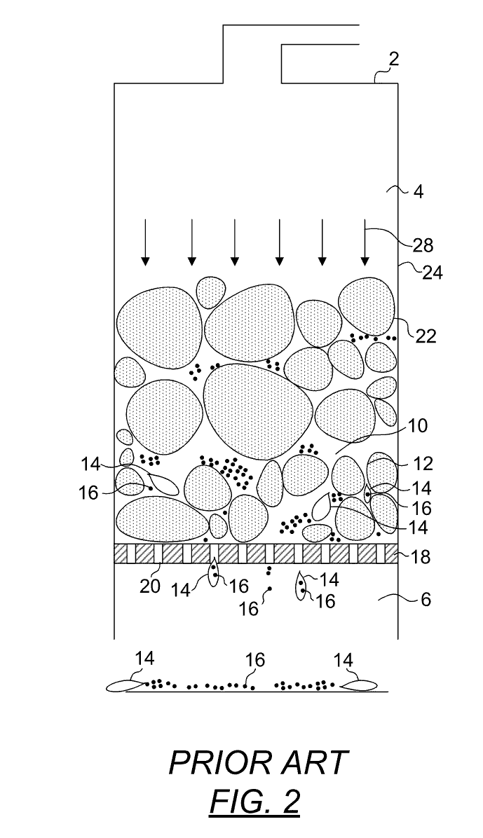

FIG. 2 depicts another prior art means for dewatering a porous matrix 22 using compressed gas. Compressed gas at higher pressure 28 is provided at the upstream end 4 of the porous matrix while the downstream end 6 is disposed at a lower pressure as compared to the upstream end 4. In some applications, vacuum is applied to the downstream end 6 while the upstream end is supplied with compressed gas or ambient gas pressure. Again, liquids 14 and small solids 16 are mobilized from the upstream end 4 to the downstream end 6 of the porous matrix 22. If vacuum or a non-ambient pressure is applied to the downstream end 6 of the porous matrix 22, the downstream end 6 of the porous matrix must be enclosed for such condition to exist. In some applications, the dewatering method of FIG. 2 is used in conjunction with the dewatering method of FIG. 1 to increase the level of dewatering of the porous matrix 22. In other applications, heat and/or chemicals are additionally applied to further reduce the amount of moisture retained in the porous matrix 22. Thermal drying, in particular, consumes tremendous amounts of energy when conducted within a vessel, or necessitates the spread of such porous materials over large areas to improve drying.

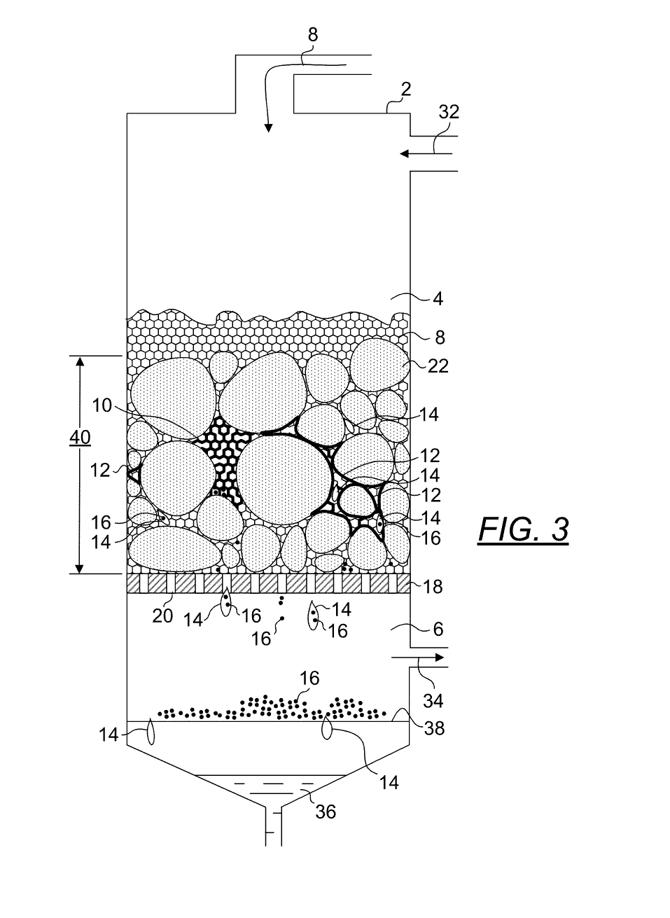

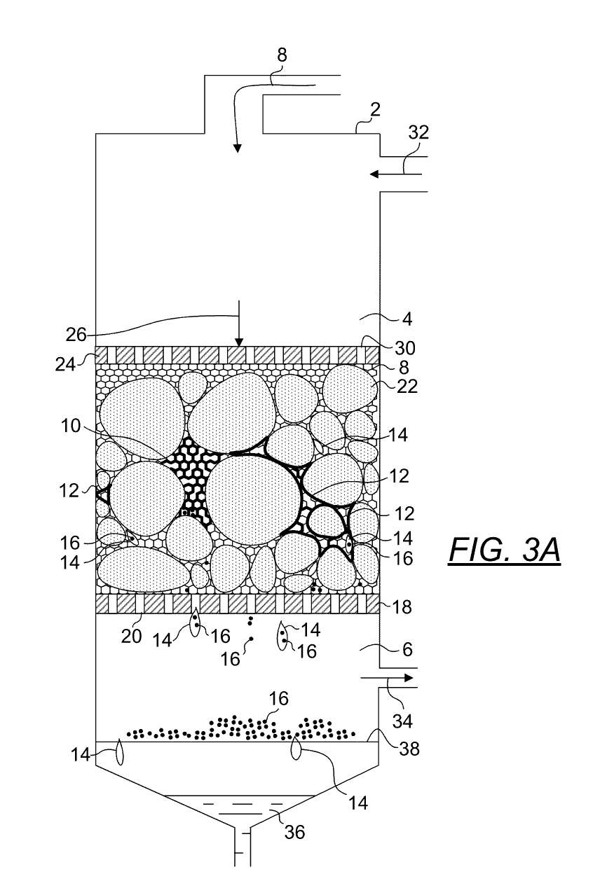

FIG. 3 depicts one embodiment of the present invention for dewatering a porous matrix 22 using foam drive. Similar to the setups shown in embodiments of FIGS. 1 and 2, the porous matrix 22 is disposed in a chamber 2 and atop a sieve 18. The porous matrix 22 can be a filter cake having been exposed to other types of dewatering treatments such as mechanical, chemical and/or thermal or it can be a virgin filtrate. Foam or surfactant mixture 8 is supplied to the upstream end 4 of the porous matrix 22.

Applicant discovered that the pressure differential between the upstream and downstream ends 4, 6 of the porous matrix 22 causes a pressure gradient that is essential in creating and maintaining foam drive through the porous matrix 22. Dewatering of the porous matrix 22 is improved by applying the concept of low-density fluid drive to the displacement of residual moisture normally adhering to the porous matrix 22 when conventional filtration or centrifugation is employed.

In one embodiment, low-density gases such as air, CO₂, and N₂ can be forced through a wet filter cake either by application of pressure or vacuum (or combination) to generate foam which in turn removes the water in interstices. In one embodiment, compressed gas of air, CO₂ or N₂ is supplied through an entry point 32 of gas at the upstream end 4. In another embodiment, the downstream end 6 is disposed in vacuum to encourage foam transport through the porous matrix 22. In yet another embodiment, the pressure differential between the upstream and downstream ends 4, 6 is provided by a combination of the compressed gas at the upstream end 4 and a vacuum on the downstream end 6. In all embodiments, the compressed gas supplied via the entry point exits at exit point 34.

As shown in FIG. 3, surfactant-stabilized foam 8 tends to flow through the porous matrix 22 in a “plug-flow” manner. Therefore foams provide a more effective sweep and penetration, with reduced channeling compared to the use of flowing air or liquid individually as depicted in FIG. 2. Strong foam will preferentially accumulate in the higher permeability zones or large interstices 10 of the porous matrix 22 due to their higher viscosity and thus facilitate detouring of the liquid 14 trapped in the porous matrix 22 into the smaller capillaries or interstices 12, providing a more complete removal of residual water 14. This figure further demonstrates the use of foam drive to increase the recovery of small solids 16. Also, water 14 in the finer capillaries or interstices 12 is partitioned into the foam lamellae and expelled with the majority of the foam 8. As lamellae must survive mobilization and division to reproduce, the pressure differential between the upstream and downstream ends 4, 6 also depends on the ability of the surfactant to stabilize lamellae against high capillary pressure and the stresses of mobilization.

With more stable lamellae, fewer lamellae must be mobilized to initiate foam generation and the lower the value of pressure gradient required. In one embodiment, Applicant discovered that a pressure differential of about 60 psi is suitable in driving foam 8 through the porous matrix 22 of having thickness 40 of from about 3 mm (pressure gradient of 60 psi/3 mm or 6100 psi/ft) to about 5 mm (pressure gradient of 60 psi/5 mm or 3660 psi/ft) with Tergitol™. In another embodiment, a minimum pressure gradient of from about 800 to about 1000 psi/ft is required to create and maintain foam drive through porous matrix such as mineral fines for N₂ and air. If CO₂ is used, the minimum pressure gradient of 20 times lower, i.e., from about 40 psi/ft to about 50 psi/ft is possible. The requirement for significantly high pressure gradient to create and maintain foam further serves as evidence of the presence of strong foam.

Strong foam exhibits a polyhedral structure in the larger channels or interstices 10 and imparts a higher viscosity and resistance to gas flow (lower gas mobility) in those areas compared to flow through the smaller pores or interstices 12. Indeed, laboratory research suggests that gases may even be diverted preferentially into the lower porosity regions 12. As a consequence, overall foam/gas flow through the filter medium occurs in a “plug-flow” manner and pushes out significantly more liquid 14. So the normally deleterious cracks in the cake present much less of a hindrance to effective dewatering. Another advantage of the presence of foam within a porous matrix is that water in the finer capillaries 12 is partitioned into the foam lamellae and then expelled along with the foam. Partitioning is a consequence of differences in surface tension.

Readily available gases such as air or N₂ may be employed as the components of the foams, as well as the driving force for foam flow. CO₂ foams may provide additional advantages in that much lower pressure gradients are required to produce them as compared to N₂, by as much as a factor of 20. A contributing factor to their greater ease of formation is the much lower surface tension of a CO₂ bubble in surfactant solution than for an equivalent N₂ bubble. The consequence is that strong CO₂ foams are more readily applicable to vacuum filtration where maximum pressure drop is limited. CO₂ foams are conveniently and commonly available, much like the materials available in fire extinguishers.

Strong foams are formed generally, in the presence of surfactant, only when there is a sufficient fluid injection velocity or pressure gradient, as disclosed in P. A. Gauglitz, et al, Chemical Engineering Science 57 (2002) 4037-4052 (hereinafter Gauglitz), hereby incorporated by reference. So strong foam formation is evidenced by an increase in the pressure drop or gradient when gas or liquid flow occurs through a given thickness of filter cake depth. The size of such a pressure drop depends on the nature of the gas, with CO₂ presenting a much lower drop than air or N₂. Once foam generation occurs, one can maintain strong foam at flow rates and even pressure drop below that at which foam generation was triggered. Further observed by Gauglitz, there is a critical pressure gradient where “weak” or “coarse” foam is abruptly converted into strong foam, with a reduction of one to two orders of magnitude in total mobility.

Foam 8 can be generated in at least three different ways. In its simplest version, foam is generated externally in an apparatus, and it is then conveyed to or spread onto the surface or upstream end of the porous matrix that has already been formed by conventional filtration. The foam is forced through the wet cake by either a mechanical device or gas pressure, or a combination thereof. A vacuum applied to the downstream side of the cake or centrifugal force may also provide the motive force to the foam 8.

In a second version, gas and surfactant are introduced into the slurry from which solids and liquids are to be separated such that foaming occurs just before the entire mixture is subjected to filtration. In a simplified approach, product froth may be taken directly from a flotation processing step and filtered immediately, and thus exhibit the advantages of foam drive. Foam 8 is generated by dispersing a surfactant/water mixture directly in the slurry (prior to filtration) and agitating the slurry with a supply of gas to create foam within the slurry. The resultant foam mixture is then filtered.

In a third version, strong foam is created within the pores of the filter cake as fluid flow proceeds through it, even while the filter cake is forming. The appropriate type and amount of surfactant need to be present in the feed slurry. Foam 8 is generated in situ by forcing mixed streams of surfactant-laden water and gas through the wet filter cake, a phenomenon already demonstrated for enhanced in-situ oil recovery from porous strata. In one preferred embodiment, CO₂ is used to generate foam as the required pressure gradient for strong foam generation is substantially lower for CO₂ foam. Thus CO₂ foam may be effective in lower-pressure filtration equipment, such as vacuum filters. Alternatively, foam 8 may be generated in situ within the filter cake 22 by pressure reduction, if the residual moisture contains sufficient frother and dissolved gas, such as CO₂. Most of the freshly formed foam is then removed by the applied vacuum system. Dissolution of CO₂ into the residual water may be controlled by an in situ pretreatment of the cake with pressurized CO₂, or a conventional CO₂ pressure filtration may dissolve enough gas such that the residual water will effervesce during a final vacuum step. Residual water left behind in the cake after a first filtration could be displaced in an intermediate flush step conducted at pressure with externally treated (dissolved CO₂ and frother) water. Foam can contain very little water, and so residual foam remaining behind in the pores of the filter cake contributes much less moisture.

Extracted liquid 36 is collected and drained from the chamber 2 while solids 16 are gathered in the solids collector 38.

A vast number of surfactants produce foams including anionic, nonionic, as well as cationic types. Choices can be made based on cost, availability, harmlessness, effectiveness, etc. Tests for enhanced oil recovery have employed Chaser SD1000 (alkyl sulfonate), Chaser CD1040, Chaser CD1045 (from Chevron Chemical Company), Aerosol MA801 (sodium dihexyl sulfosuccinate from CYTEC Industries), STEOL CS-330 (a mixture of Poly(oxyethylene) lauryl ether and sodium lauryl ether sulfate from Stephan Co.), Bio-terge AS-40 (Stephan Co.), Shell NEODOL 91-8 (Shell Chemical Co.).

Tests for environmental remediation included the anionic surfactants Aerosol MA801 (sodium dihexyl sulfosuccinate from CYTEC Industries), Dowfax 8390 (disodium hexadecyldiphenyloxide disulfonate from Dow Chemical Co.) and Bio-Terge AS-40 (sodium a-olefin sulfonate from Stephan Co.). Also tested was nonionic surfactant Triton X-100 (decyldimethyl phosphine oxide from BASF Corp.). Numerous other surfactants are being employed in commercial processes, household products, and more basic experimental investigations of foam properties and foam flows.

In one embodiment and in the interest of reusing mineral processing by-products, product froth taken directly from a flotation processing step disclosed in U.S. Pat. No. 7,992,718 to Applicant, may be used as the surfactant for the present foam drive. In another embodiment, Tergitol™ was found to be cost effective and suitable as surfactant for creating foam for the present foam drive. Tergitol™ NP-7 and Tergitol™ NP-9 are nonylphenol ethoxylates that deliver a combination of economy and performance in a wide variety of cleaning applications. These nonionic surfactants provide excellent all-purpose detergency and wetting, as well as solubilization and emulsification. They are used in household and industrial laundry detergents, all purpose cleaners, hard surface cleaners, degreasers, and transportation cleaners.

Further, Triton X series surfactants (octylphenol ethoxylates), also nonionic, may also be used. They are employed in almost every type of liquid, paste, and powdered cleaning compound, ranging from heavy-duty industrial products to gentle detergents.

FIG. 3A depicts another embodiment of the present invention for dewatering a porous matrix 22 using combined foam drive, compressed gas introduced through the entry point 32 and compressing plate 24. This embodiment is essentially the combination of the embodiments shown in FIG. 1 and the use of foam drive. As disclosed in this embodiment, the present foam drive is used to improve the operation and effectiveness of commercial pressure filters. Present pressure filters have become large machines with up to 150 m² filter area and handling 120-150 tons per hour of concentrates and minerals. Whether batch, or automated, these filters go through several steps, some of which may be optional. In situ foam generation may be induced during the initial filtration step, if sufficient slurry feed pressure is applied, and appropriate surfactant is present. This is followed by a typical cake washing step which may be replaced by a foam washing step in which foam replaces wash liquid and is pumped into the chambers instead, and subsequently forced through the cake by gas pressure or by inflatable diaphragm pressure or compressing plate 24. Typical commercial pressure filters operate at pressures ranging from 90 to 368 psi, more than enough to effect foam drive, especially if CO₂ gas is employed. Exemplary commercial pressure filters include Larox® and Delkor®. A final air or gas blowing step may then be used to remove any residual foam from the filter cake. Apertures 30 are disposed on the compressing plate 24 to enable ready application of compressed gas for foam generation and drive through the porous matrix 22 or the gas blowing step.

Commercial Larox® automatic pressure filters operate up to 235 psi and maximum chamber thickness of about 60 mm. The maximum filter cake thickness used is about 40 mm. Commercial Delkor® filter presses operate up to 368 psi and maximum cake thickness of from about 15 to about 50 mm.

In another embodiment, the porous matrix of FIG. 3 or of FIG. 3A is subjected to centrifugal filtration similar to the centrifugal filtration method disclosed in U.S. Pat. No. 6,440,316 to Yoon et al. prior to applying foam drive or concurrently with foam drive. Said disclosure is incorporated by reference in its entirety. In yet another embodiment, the porous matrix of FIG. 3 or of FIG. 3A is subjected to pressure filtration similar to any one of the pressure filtration methods disclosed in Townsend, hereby incorporated by reference.

Foam drive tests were conducted on Georgia clay of very fine particle sizes, over about 90% minus 2 microns using an experimental setup substantially similar to the setup shown in FIG. 3. With Tergitol™ NP-7 as the foaming agent the clay slurry was dewatered to about 25% moisture in a pressure filter operating at a pressure differential of 60 psi. This is a substantial improvement over the typical 35 to 45% result obtained when employing conventional pressure filtration without foam drive. Roughly the same 25% moisture content was achieved either by addition of an externally-generated foam to the top of the filter cake, or by aeration of the feed slurry containing the detergent prior to the pressure filtration step, with perhaps a slight advantage resulting with the former technique. Tergitol™ NP-9 also gave the same result as Tergitol™ NP-7. The clay industry goal is about 30% moisture for its final product and this goal is now achieved commercially by thermally drying a portion of the filter cake and back blending the dry portion into the wet portion of the filter cake. Another foam-drive test on fly-ash pond concentrate obtained by froth flotation yielded about 20% moisture, whereas conventional vacuum filtration produces only about 39%.

The choice of surfactant for foam generation can be tailored to the requirements of the feed stock and/or the product. For example, the use of Tergitol™ as foaming agent in clay slurries is an advantage because it does not adsorb onto the clay surface, and thus does not contaminate the filter product.

The following examples and comparison runs further illustrate the practice of the present invention and its advantages over filtration alone. Crude Georgia clay, as mined, contains various forms of discoloring impurities, two major impurities being anatase (TiO₂) and iron oxides (Fe₂O₃), which detrimentally affect the brightness of kaolin. In practice, clay is usually purified with various methods such as high gradient magnetic separation (HGMS), flotation, selective flocculation and chemical bleaching to remove these impurities for required brightness. The cleaned clay is then dewatered using drum and high-pressure filters, which yields a product with about 40% to 60% moisture in the filter cake. In addition, part of the moisture in the filter cake is spray dried using a natural gas flame to obtain about 70% to 90% solid content (or about 30% to 10% moisture) product before marketing. The spray drying is costly and not environmentally benign, but it is the only method used to produce relatively dry clay. A part of the dry clay is mixed into the dispersed slurry to obtain 70% solids clay product and shipped to paper mills.

A series of laboratory dewatering tests were conducted on George clay samples received from Thiele Clay Company using the foam drive technique at natural pH and at acidic pH (i.e., in bleached clay sample). A laboratory pressure filter was used for all tests at 60 psi pressure. The cake thickness was about 2 to 5 mm. In one test, the cake moisture was reduced to about 25% for an as-received sample. On the other hand, the moisture was reduced to about 30% for the bleached clay, but at the benefit of a faster filtration rate.

Conventionally, a multiple-step dewatering/drying process is required to obtain clay product that contains about 30% moisture. The difficulty in dewatering clay slurry is due to the surface hydrophilicity and the ultrafine particle size of clay, in which over about 90% is finer than 2 microns. Alum is also added to the slurry to coagulate the clay and to aid in dewatering. Alum did not aid in reducing the moisture even though it increased the kinetics of filtration.

### Samples:

The Georgia clay was a flotation product and contains approximately 25% solids. The clay slurry is diluted with tap water to about 5% to 8% solid. A set of tests was conducted at natural pH of about 7.2, while another set of tests was done on the bleached clay sample. The bleaching process was carried out in a mild sulfuric acid solution (pH 3 to 3.5) for at least 4 hours in the presence of a reducing agent sodium hydrosulfite (Na₂S₂O₄) to keep the dissolved iron in a soluble ferrous state and prevent the formation of ferric hydroxide precipitate.

### Foam Dewatering Technique:

Two ways of applying foam drive to clay dewatering were tested. First, a foam-generating agent was added to the clay slurry, and then agitated strongly with air blown into the slurry until the slurry was filled with foam. The foamy slurry is subjected to the pressure filtration tests. Second, foam was generated separately by agitating the foam-generating agent containing water in presence of blowing air. Then the foam was added onto the top of clay cake inside the pressure filter after the cake has formed in the pressure filter.

### Filtration:

All filtration tests were conducted using a laboratory-scale apparatus. In each dewatering test, a desired volume of clay slurry was agitated in a mixer for a period of time after reagents or surfactants were added, and then transferred to the apparatus. During filtration, cake formation time and drying cycle time were recorded. The cake formation time is the time required to remove all free water from the surface of the filter cake and is indicative of dewatering kinetics. The drying cycle time is the allotment of time after cake formation in which the pressure difference through the cake was continued for further moisture reduction. The air pressure was set at 60 psi for all the tests. #44 filter papers manufactured by Whatman Company were chosen as filtration media. The filtrate obtained with #44 filter paper was always clear.

### Results

1. Clay Dewatering Tests at Natural pH (at about pH 7.2)

In order to investigate the effect of foam on clay dewatering, clay sample was conditioned with various dosages of Tergitol™ NP-7 (a surfactant capable of generating foam in solution) and aerated to create a foamy environment. Table 1 and FIG. 4 show that Tergitol™ alone could reduce the cake moisture down to as low as about 25%. Another way of using foam is adding foam that is generated separately on the top of the cake. Once the cake is formed, it is possible to add foam to the top of the cake. The test results showed that creating foam inside the slurry or adding foam on the top of the cake for the dewatering tests yielded approximately similar moisture reductions.

TABLE 1
Effect of Tergitol ™ Addition as Foaming
Agent on Dewatering of Georgia clay

| | Moisture (%) |
|---|---|
| Reagent Dosage (lb/ton) | Tergitol ™ (With Air) |
| 0 | 39.14 |
| 3 | 26.69 |
| 10 | 26.35 |
| 30 | 25.52 |

The clay slurry of Table 1 was diluted from about 25% to about 8%. The measured pH was about 7.14. The conditioning time was about 5 minutes. The gauge pressure applied to the upstream end 4 of the cake was about 60 psi. The cake thickness for baseline was from about 1.5 to about 2 mm, with reagent thickness of about 2 to about 4 mm. The cake formation time for baseline was about 25 minutes, with reagent formation time of from about 20 to about 25 minutes. The drying time was about 5 minutes.

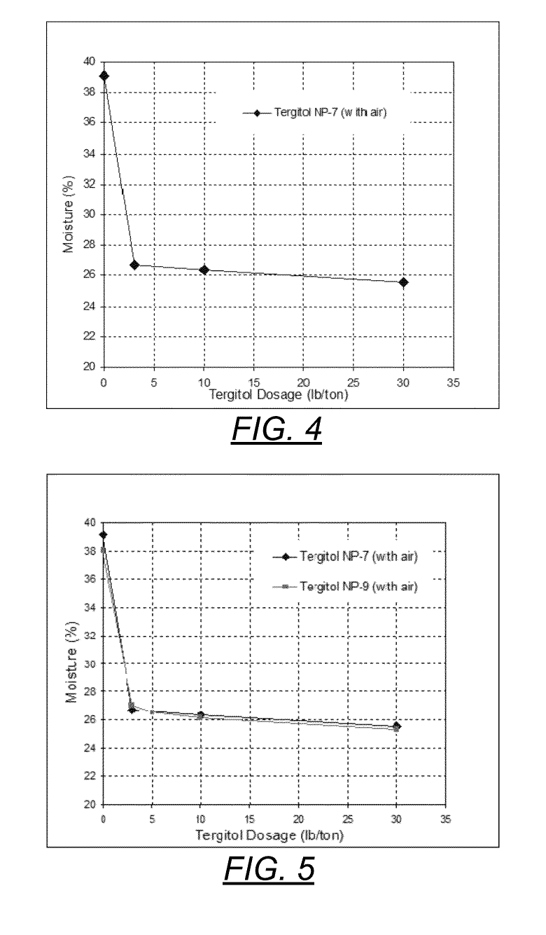

FIG. 4 depicts the results of Georgia Clay dewatering tests employing Tergitol™ NP-7 surfactant as foam drive. Table 2 and FIG. 5 show the effect of different types of Tergitol™ addition on dewatering of Georgia clay. Results show that Tergitol™ NP-9 works as well as Tergitol™ NP-7. Both could reduce the cake moisture down to 25%. Actually these two reagents are the same type of surfactant but their Hydrophilic-Lipophilic Balance (HLB) number is slightly different: 12 for NP-7 and 12.9 for NP-9.

One of the advantages for using Tergitol™ as foaming agent is that it does not contaminate the clay surface because it does not adsorb onto the clay surface.

TABLE 2
Effect of Tergitol ™ Addition on Dewatering
of Georgia clay as Foaming Agent

Moisture (%)

| | | Tergitol ™ |
|---|---|---|
| Reagent Dosage (lb/ton) | Tergitol ™ (NP-7) | (NP-9) 5 lb/ton |
| 0 | 39.14 | 38.04 |
| 3 | 26.69 | 27.01 |
| 5 | — | 26.52 |
| 10 | 26.35 | 26.11 |
| 30 | 25.52 | 25.33 |

The experiments depicted in Table 2 were performed at natural pH. Tergitol™ was added and conditioned for 1 minute. The slurry became foamy with aeration. The cake formation time was about 20 to about 25 minutes.

TABLE 3
Effect of Tergitol ™ with Thick
Cake on Dewatering of Georgia clay

| Reagent Dosage (lb/t) | Moisture (%) |
|---|---|
| 0 | 43.45 |
| 1 | 29.19 |
| 5 | 29.94 |
| 10 | 30.23 |

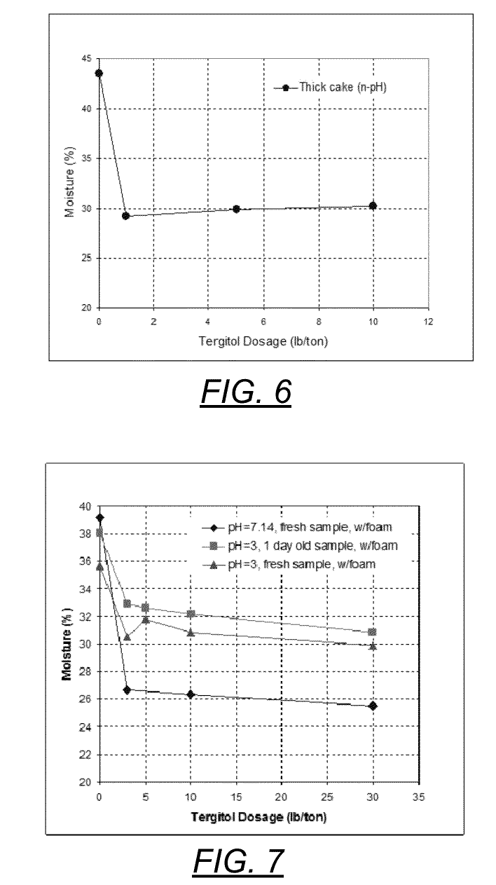

All the tests depicted in Table 2 were conducted at about 2 to about 4 mm thick cake by using about 50 ml slurry. Table 3 and FIG. 6 show the test results obtained with approximately 5 mm thick cake when about 100 ml slurry was used for filtration tests. As expected, the increased cake thickness yielded higher cake moisture, but the moisture reduction from about 43% to about 29% is still significant.

2. Clay Dewatering Tests at Acidic pH (at about pH 3 to about 3.5)

As introduced elsewhere herein, clay is usually further treated by chemical bleaching after separation in order to achieve the required brightness. In industry, the leaching process takes place in the presence of sodium hydrosulfite at an acidic pH (at about pH 3) to keep the dissolved iron in a soluble ferrous state and prevent the formation of ferric hydroxide. In this series of test, the effect of Tergitol™ as foaming agent was investigated after the clay sample was bleached in the similar manner as in the industry. The pH of slurry was adjusted to about 3 using sulfuric acid, and then sodium hydrosulfite was used as a reducing agent. Alum was also added to the clay slurry to help coagulation and increase the dewatering kinetics. Table 4 and FIG. 7 show the comparison of dewatering results at natural pH and acidic pH. The cake moisture was increased after the clay sample was bleached at acidic pH. However, the filtration kinetics was improved at acidic pH because of the coagulation effect. The cake moisture can still be lowered to about 30% when foam was generated in the slurry using Tergitol™ as foaming agent.

TABLE 4
Effect of pH on Clay Dewatering when Tergitol ™ Was
Used as Foaming Agent

| | Moisture (%) | | |
|---|---|---|---|
| Reagent Dosage | | pH 3 (1 day old | pH 3 (fresh |
| Tergitol ™ (lb/ton) | pH 7 | sample) | sample) |
| 0 | 39.14 | 38.04 | 35.25 |
| 3 | 26.69 | 32.87 | 30.50 |
| 5 | — | 32.63 | 31.78 |
| 10 | 26.35 | 32.14 | 30.82 |
| 30 | 25.52 | 30.84 | 29.87 |

The solids content of feed slurry for experiments of Table 4 was about 5 to about 6%. Tergitol™ was added to the slurry (mixed and aerated to produce foam). The applied pressure was about 60 psi. The cake thickness was about 1.5 to about 2 mm with about 50 ml slurry.

TABLE 5
Effect of Alum addition on dewatering of Georgia clay when
Tergitol ™ was Used as Foaming Agent

Moisture (%)

| Reagent Dosage | | Tergitol ™ (NP-7) |
|---|---|---|
| (lb/ton) | Tergitol ™ (NP-7) | 5 lb/ton Alum |
| 0 | 40.16 | 41.10 |
| 1 | 36.46 | 37.01 |
| 3 | 34.75 | 35.48 |
| 5 | 34.78 | 35.26 |

The pH of experiments of Table 5 was adjusted to about 3 by using sulfuric acid. About 10 lb/ton of sodium hydrosulfite and various dosages of Tergitol™ were added (mixed and aerated to produce foam). The applied vacuum was about 25 in Hg. Note that vacuum was applied as the driving force in the Alum tests rather than the 60 psi gas pressure drop employed in previous experiments. The volume of slurry was about 30 ml. The solids content was about 25%. The cake thickness without Alum was about 1.5 to about 2 mm. The cake formation time without Alum was about 120 to about 200 seconds. The cake formation time with Alum was about 50 to about 120 seconds. The dry cycle time for any one of the above experiments was about 90 seconds.

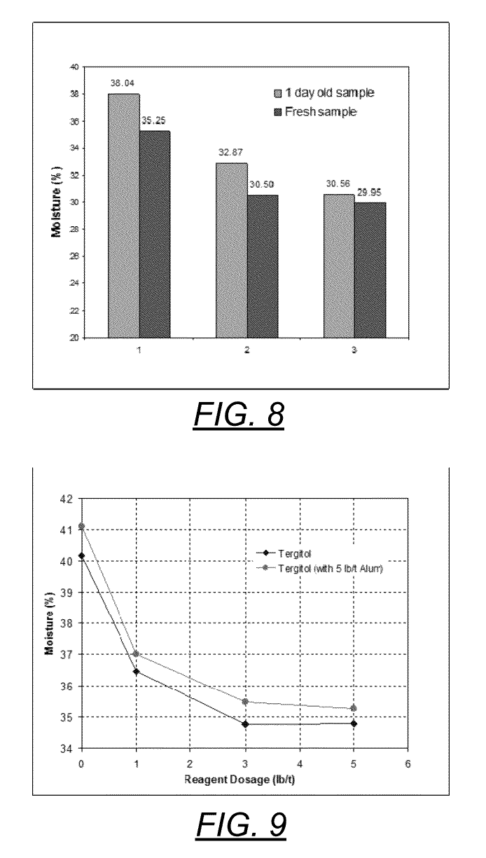

FIG. 8 shows the comparison of different manners in which to apply foam in clay dewatering, i.e., comparison of generating foam in the slurry and adding already-existent foam on the top of cake: 1—Baseline (pH adjusted to 3, and then Na₂S₂O₄ was added); 2—With 3 lbs/ton Tergitol™ addition (mixed with aeration to produce foam inside); 3—With Tergitol™ foam on top. It is seen that adding foam on the top (as in 3 above) of cake yielded only slightly lower cake moisture than generating foam in the slurry (as in 2 above). In addition, it shall be noted that the retained cake moisture increased as the bleached clay sample was aged, probably due to further coagulation during the aging process.

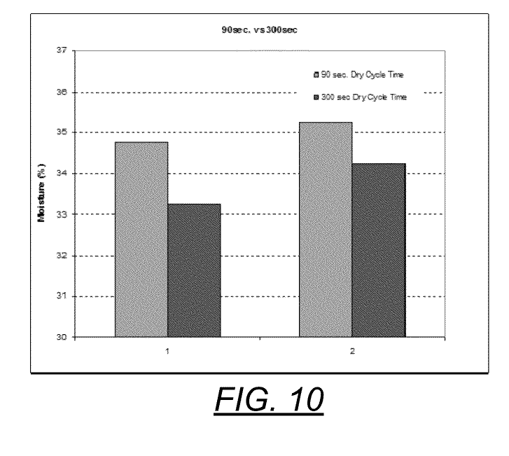

Table 5 and FIG. 9 show the effect of Alum addition as coagulating agent. Alum addition at about 5 lb/ton increased the kinetics dramatically. The cake formation time drops down to about 50 seconds from about 2 minutes, but it also caused slight increase in cake moisture. As shown in FIG. 10, the cake moisture decreased by about 1 to about 1.5% when the dry cycle time increased from about 90 seconds to about 5 minutes.

### CONCLUSIONS OF THE EXPERIMENTS

It has been shown in the above experiments that the introduction of foam in clay dewatering can help reduce cake moisture. The final moisture of unbleached clay slurry can be reduced down to about 25%, and to about 30% for bleached clay sample. The experiments further demonstrated that the method by which foam is applied in the dewatering process makes little difference in the amount by which moisture is reduced. Foam was either generated in the slurry or pre-made foam was added on the top of cake. It was further demonstrated that Alum can improve dewatering kinetics although it increases cake moisture slightly.

As Georgia clay is made up of particles of fineness in the order of 50 to 100 times smaller than materials of higher permeability as used in Gauglitz, such as sand packs, glass bead beds and porous sandstones, the pressure gradient required to cause foam drive in materials such as mineral fines (having particle sizes closer to those materials disclosed in Gauglitz) is expected to be significantly lower. According to Gauglitz, the minimum required pressure gradient depends on the type, porosity or permeability of the porous matrix and the type of gas used in the foam drive.

1. A method for extracting liquid and/or solids from interstices of a porous matrix, wherein an exposed upstream end is disposed at a first pressure and an exposed downstream end is disposed at a second pressure, said method comprising:
(a) providing a pressure differential between said first pressure and said second pressure, wherein said first pressure is higher than said second pressure;
(b) providing foam by injecting a surfactant/water mixture into said porous matrix and applying a secondary pressure to enable transformation of said surfactant/water mixture into foam in-situ within said porous matrix and force penetration of said foam through said porous matrix,
wherein said pressure differential is configured to cause a pressure gradient which causes foam movement through the interstices of said porous matrix to extract said liquid and/or solids through said exposed downstream end.

2. (canceled)

3. The method of claim 1, further comprising a gas blowing step applied at said exposed upstream end of said porous matrix to remove any residual foam from said porous matrix.

4. The method of claim 1, wherein said pressure gradient ranges from about 40 to about 6100 psi/ft of a thickness that is substantially the perpendicular distance between said two exposed ends.

5. The method of claim 1, wherein Alum is added to said porous matrix to increase the kinetics of said foam movement.

6. A method for extracting water from interstices of a filter cake wherein an exposed upstream end is exposed to a first pressure and an exposed downstream end is exposed to a second pressure, said method comprising:
(a) providing a pressure differential between said first pressure and said second pressure, wherein said first pressure is higher than said second pressure and said pressure differential is effectuated with CO₂; and
(b) providing foam on said exposed upstream end,
wherein said pressure differential is configured to cause a pressure gradient which causes foam movement through the interstices of said filter cake to extract said liquid and/or solids through said exposed downstream end.

7. The method of claim 6, further comprising:
(a) mechanically compressing said filter cake to reduce said filter cake from a first volume to a second volume;
(b) applying compressed gas to said exposed upstream end of said filter cake,
wherein additional water and residual foam are driven from interstices of said filter cake from said exposed upstream end through said exposed downstream end of said filter cake.

8. The method of claim 6, wherein said foam is provided in a process selected from the group consisting of:
(a) dispersing a surfactant/water mixture into said porous media to form a slurry and agitating said slurry with a supply of gas to create foam within said slurry;
(b) disposing foam generated externally to said exposed upstream end; and
(c) injecting a surfactant/water mixture into said porous matrix and applying a secondary pressure to enable transformation of said surfactant/water mixture into foam in-situ within said porous matrix and force penetration of said foam through said porous matrix.

9. (canceled)

10. The method of claim 6, wherein said pressure gradient ranges from about 40 to about 6100 psi/ft of a thickness that is substantially the perpendicular distance between said two exposed ends.

11. The method of claim 8, wherein said surfactant of said surfactant/water mixture is selected from the group consisting of nonylphenol ethoxylates, alkyl sulfonate, sodium dihexyl sulfosuccinate, mixture of Poly(oxyethylene) lauryl ether and sodium lauryl ether sulfate, sodium dihexyl sulfosuccinate, disodium hexadecyldiphenyloxide disulfonate, sodium a-olefin sulfonate and decyldimethyl phosphine oxide.

12. The method of claim 6, wherein Alum is added to said filter cake to increase the kinetics of said foam movement.

13. An apparatus for increasing the effectiveness of extraction of water from interstices of a filter cake wherein an exposed upstream end is exposed to a first pressure and an exposed downstream end is exposed to a second pressure, said apparatus comprising:
(a) a first gas compressor configured to provide a pressure differential between said first pressure and said second pressure, wherein said first pressure is higher than said second pressure; and
(b) a foam generating apparatus configured to cause foam to be generated within said filter cake,
wherein said pressure differential is configured to cause a pressure gradient which causes foam movement through the interstices of said filter cake to extract said liquid and/or solids through said exposed downstream end.

14. The apparatus of claim 13, said apparatus further comprises:
(a) a mechanical compactor configured for reducing said filter cake volume from a first volume to a second volume; and
(b) a second gas compressor configured for applying compressed air to said upstream end of the filter cake,
wherein said mechanical compactor, said first and second gas compressors are configured to drive water from interstices of said filter cake from said exposed upstream end through said exposed downstream end of said filter cake.

15. The apparatus of claim 13, further comprising a centrifugal filter configured for reducing the volume of said filter cake from said second volume to a third volume, wherein said centrifugal filter is configured to drive water from interstices of said filter cake from said exposed upstream end to said exposed downstream end of said filter cake.

16. The apparatus of claim 13, wherein said filter cake is selected from the group consisting of coal fines, fly ash, mineral fines and clay.

17. The apparatus of claim 13, wherein said pressure gradient ranges from about 40 to about 6100 psi/ft of a thickness that is substantially the perpendicular distance between said two exposed ends.

18. The apparatus of claim 13, wherein said foam generating apparatus comprises a first device for injecting a surfactant/water mixture into said filter cake and a second device for applying a secondary pressure to enable transformation of said surfactant/water mixture into foam in-situ within said filter cake and force penetration of said foam through said filter cake.

19. The apparatus of claim 13, wherein said pressure differential is effectuated with a gas selected from the group consisting of air, CO₂ and N₂.

20. The apparatus of claim 13, wherein Alum is added to said filter cake to increase the kinetics of said foam movement.
